(19) United States
(12) Patent Application Publication
(10) Pub. No.: US 2021/0262516 A1
(43) Pub. Date: Aug. 26, 2021

(54) SUPPORT FRAME USING BALL MEMBERS

(71) Applicant: Sun Ho HWANG, Jeju-si (KR)

(72) Inventor: Sun Ho HWANG, Jeju-si (KR)

(21) Appl. No.: 17/253,242

(22) PCT Filed: Jul. 16, 2018
(86) PCT No.: PCT/KR2018/008037

§ 371 Date: Dec. 17, 2020

(30) Foreign Application Priority Data
Jun. 20, 2018 (KR) 10-2018-0070725

(51) Int. Cl. F16C 11/06; F16M 11/24; F16M 11/16

(52) U.S. Cl. CPC F16C 11/06; F16C 11/106; F16M 11/16; F16M 11/242

(57) ABSTRACT

Disclosed is a support frame using ball members. The support frame using ball members of the present invention includes a support main body having a lower body provided with a plurality of lower cutout holes and an upper body provided with a plurality of upper cutout holes at positions corresponding to the plurality of lower cutout holes; a ball connector part provided with a plurality of ball members disposed in a plurality of space portions provided by the plurality of lower cutout holes and the plurality of upper cutout holes and coupled with a mounting object including at least one support; and a fastening part which is provided on the support main body and presses the plurality of hollow ball members by the lower body and the upper body to fix the positions of the plurality of ball members.

### CROSS-REFERENCE TO RELATED APPLICATIONS

This application claims the priority of Korean Patent Application No. 10-2018-0070725 filed on Jun. 20, 2018, in the Korean Intellectual Property Office, the disclosure of which is incorporated herein by reference.

### BACKGROUND OF THE INVENTION

### Field of the Invention

The present invention relates to a support frame, and more particularly, to a support frame using ball members capable of being utilized as various holders while replacing existing camera tripods.

### Description of the Related Art

An existing tripod technology is a market that lacks the technological advancement of the tripod market, which has still used the same technology based on the US patent in 1982.

The existing tripod has a structure with three supports and a center column that maintains a central vertical position. In order for the user to use the tripod, the three supports and the center column need to be individually manipulated, and the existing technology has a lot of discomfort to be used in a curved support surface or slope/special terrain as a function of a tripod to support only the vertical portion.

In addition, the current cameras have been changed into a market which has been changed into small, light, and high-definition devices, and in order to take pictures in various environments (a situation of a special support surface rather than the horizontal surface) using the cameras, since the existing tripod has a limit of support, improvement measures thereof are required.

The above-described technical configuration is the background art for assisting the understanding of the present invention, and does not mean a conventional technology widely known in the art to which the present invention belongs.

### SUMMARY OF THE INVENTION

Therefore, an object of the present invention to be achieved is to provide a support frame using ball members that can be utilized as various holders while replacing an existing camera tripod.

According to an aspect of the present invention, there is provided a support frame including: a support main body having a lower body provided with a plurality of lower cutout holes and an upper body provided with a plurality of upper cutout holes at positions corresponding to the plurality of lower cutout holes; a ball connector part provided with a plurality of ball members disposed in a plurality of space portions provided by the plurality of lower cutout holes and the plurality of upper cutout holes and coupled with a mounting object including at least one support; and a fastening part which is provided on the support main body and presses the plurality of hollow ball members by the lower body and the upper body to fix the positions of the plurality of ball members.

The fastening part may include a shaft part coupled to the lower body and the upper body; and a lever part rotatably coupled to the shaft part to press the lower body and the upper body in a direction of the plurality of ball members.

The lever part may include a clamping head which is rotatably coupled on an upper end of the shaft part and inserted into an upper fastening groove provided on the upper body and a lower fastening groove provided on the lower body to press the upper body and the lower body; and a lever handle which is provided on a lower end of the clamping head to be provided as a handle of a user.

The lever part may further include an extension part provided at a lower end of the lever handle with a larger width than the lever handle.

The lever part may further include a lower rotation support part which is supported by a base body of the shaft part disposed on a lower surface of the lower body to support the rotation of the shaft part; and an upper rotation support part through which the lever shaft of the shaft part disposed on the upper surface of the upper body passes in the central portion to support the rotation of the shaft portion.

According to the embodiments of the present invention, a plurality of hollow ball members are pressed to a lower body and an upper body by a fastening part provided in a support main body to fix the position of the plurality of ball members, thereby easily mounting a mounting object including a tripod.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a diagram schematically illustrating a support frame using ball members according to an embodiment of the present invention;

FIG. 2 is a lateral view of FIG. 1;

FIG. 3 is a cross-sectional view of FIG. 1;

FIG. 4 is an exploded perspective view of FIG. 1;

FIG. 5 is a plan view of an upper body illustrated in FIG. 4;

FIG. 6 is a cross-sectional view taken along line A-A′ of FIG. 5; and

FIG. 7 is a schematic operation diagram of the embodiment.

### DETAILED DESCRIPTION OF THE PREFERRED EMBODIMENT

In order to fully understand the present invention, operational advantages of the present invention and objects to be achieved by implementing the present invention, the present invention will be described with reference to the accompanying drawings which illustrate preferred embodiments of the present invention and the contents illustrated in the accompanying drawings.

Hereinafter, preferred embodiments of the present invention will be described in detail with reference to the accompanying drawings. Like reference numerals illustrated in the respective drawings designate like members.

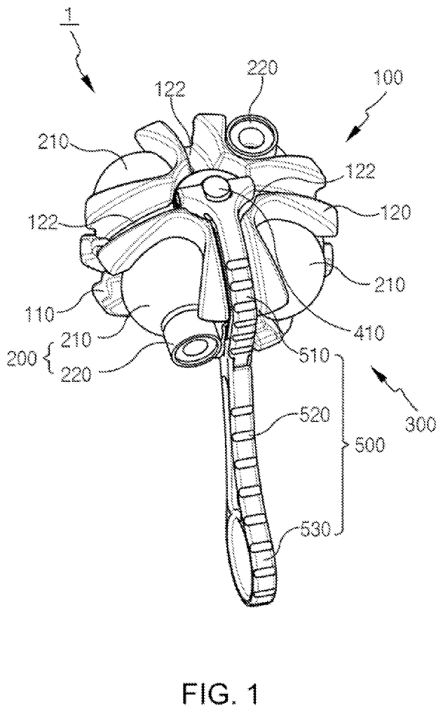

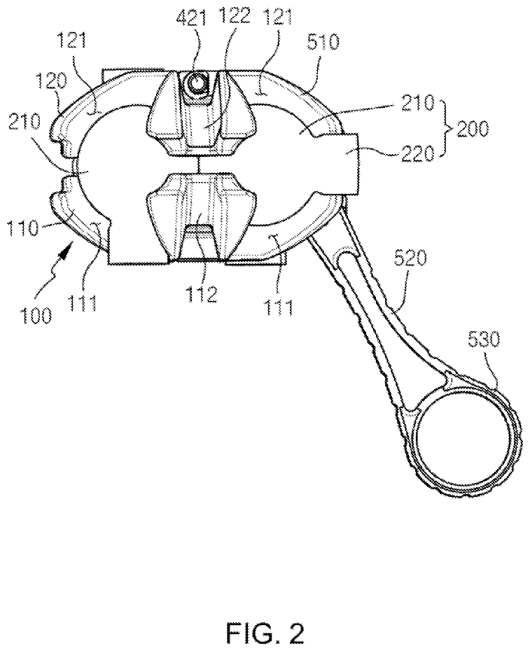

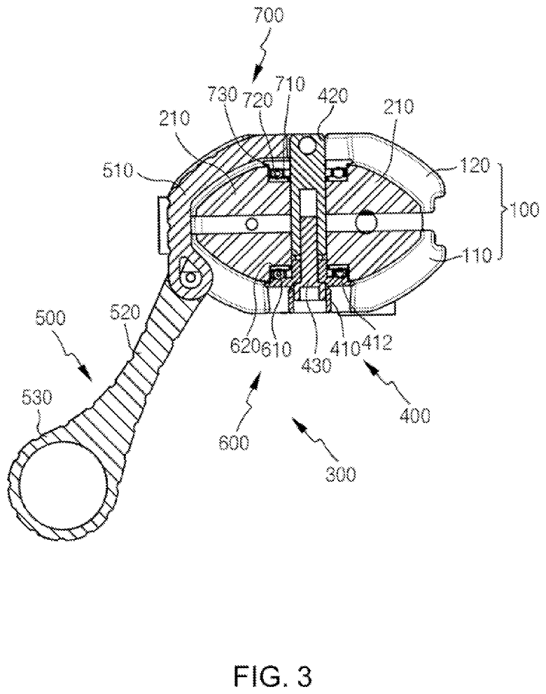

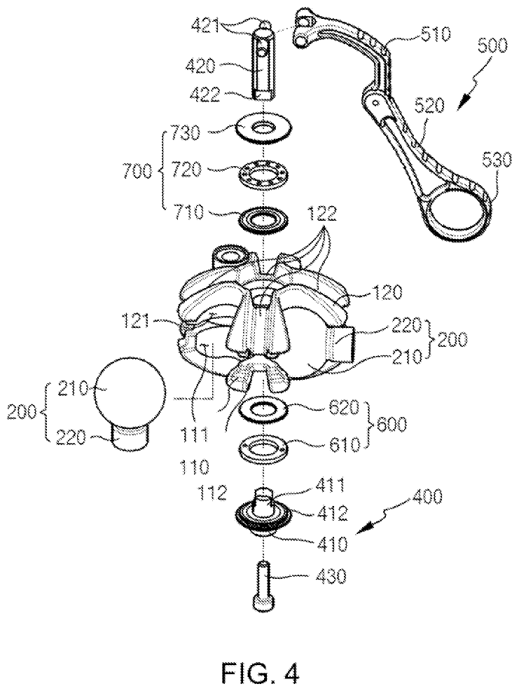

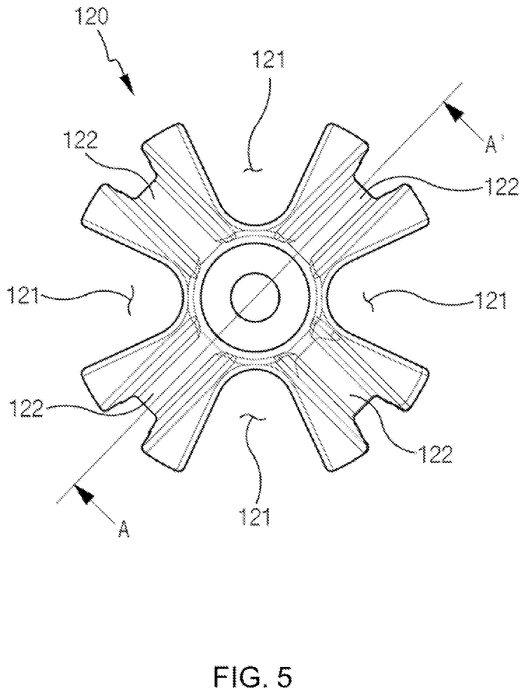

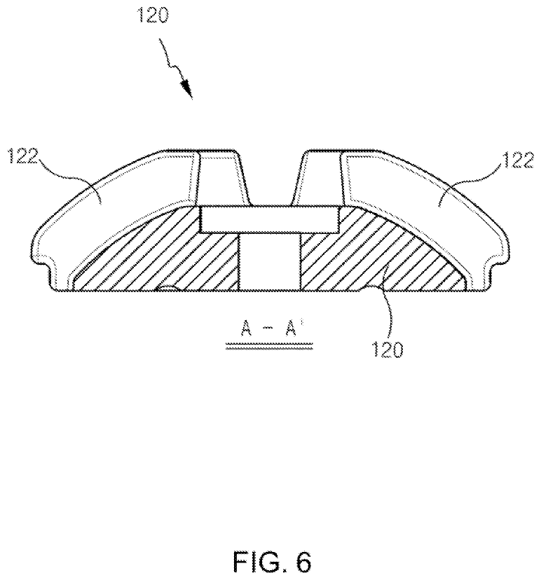

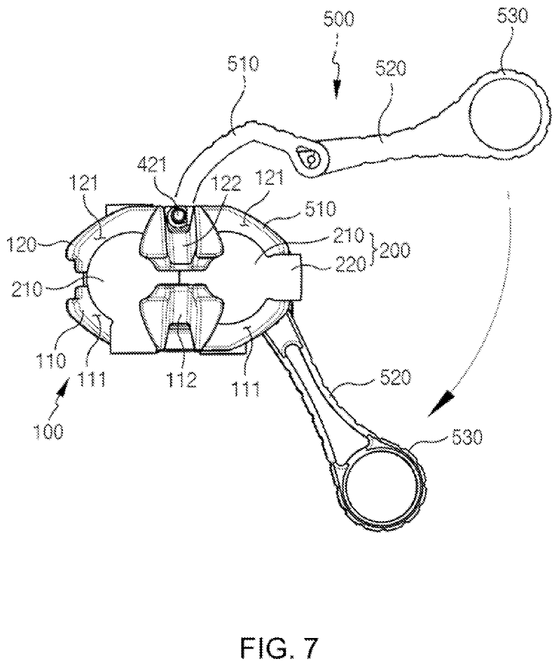

FIG. 1 is a diagram schematically illustrating a support frame using ball members according to an embodiment of the present invention, FIG. 2 is a lateral view of FIG. 1, FIG. 3 is a cross-sectional view of FIG. 1, FIG. 4 is an exploded perspective view of FIG. 1, FIG. 5 is a plan view of an upper body illustrated in FIG. 4, FIG. 6 is a cross-sectional view taken along line A-A′ of FIG. 5, and FIG. 7 is a schematic operation diagram of the embodiment.

As shown in these drawings, a support frame 1 using ball members according to the embodiment includes a support main body 100, a ball connector part 200 detachably coupled to the inside of the support main body 100 and separately coupled with a mounting object including a tripod, and a fastening part 300 provided in the support main body 100 to detachably couple the ball connector part 200 to each other.

The support main body 100, as illustrated in FIGS. 2 and 3, includes a lower body 110, and an upper body 120 disposed on the lower body 110 and fastened with the lower body 110 on the fastening part 300.

In the lower body 110 of the support main body 100, as illustrated in FIG. 2, a plurality of lower cutout holes 111 and a plurality of lower fastening grooves 112 maybe provided.

In the embodiment, as illustrated in FIG. 2, the plurality of lower cutout holes 111 may be provided from an upper end to a lower end of the lower body 110 so that the lower side of the ball member 210 and the connector body 220 are accommodated.

In addition, in the embodiment, an outer wall of the ball member 210 may be supported on an inner wall of the plurality of lower cutout holes 111, and while the plurality of ball members 210 are accommodated inside the upper body 120 and the lower body 110, the upper body 120 and the lower body 110 may be spaced apart from each other, as illustrated in FIG. 2. Due to this structure, when a lever part 500 is rotated to fix the position of the plurality of ball members 210, the lower body 110 and the upper body 120 press the plurality of ball members 210 in a direction closer to each other to fix the positions of the plurality of ball members 210.

Furthermore, in the embodiment, a plurality of four lower cutout holes 111 may be provided at regular intervals.

In the embodiment, as illustrated in FIG. 2, the lower fastening groove 112 is disposed on the same line as the upper fastening groove 122, which is a position corresponding to the upper fastening groove 122, to be provided as a space into which a lower side of a clamping head 510 and an upper end of a lever handle 520 are inserted.

In the embodiment, the lower fastening groove 112 may be provided on an upper surface of the lower body 110 so as to be disposed between the plurality of lower cutout holes 111, and a plurality of, for example, four lower fastening grooves 112 may be provided at regular intervals.

As illustrated in FIG. 2, the upper body 120 of the support main body 100 is disposed on the lower body 110 and spaced apart from the lower body 110 at a predetermined distance, and the upper body 120 serves to fix the position of the plurality of ball members 210 by pressing the plurality of ball members 210 with the lower body 110.

In the embodiment, as illustrated in FIG. 5, a plurality of upper cutout holes 121 may be provided on the upper surface of the upper body 120, and as illustrated in FIG. 2, the plurality of upper cutout holes 121 may be provided at positions corresponding to the plurality of lower cutout holes 111 in the same number as the plurality of cutout holes. In addition, in the embodiment, the plurality of upper cutout holes 121 may have a shape symmetrical to each other with the plurality of lower cutout holes 111 in a horizontal direction based on FIG. 2.

In the embodiment, a plurality of upper fastening grooves 122 may be provided on the upper surface of the upper body 120, as illustrated in FIG. 5, and the plurality of upper fastening grooves 122 may be disposed between the plurality of upper cutout holes 121, and four upper fastening grooves may be disposed at regular intervals. In addition, in the embodiment, the plurality of upper cutout holes 122 may have a shape symmetrical to each other with the plurality of lower cutout holes 112 in a horizontal direction based on FIG. 2.

The ball connector part 200, as illustrated in FIG. 4, is disposed in a plurality of space portions provided by the plurality of lower cutout holes 111 and the plurality of upper cutout holes 121, and may be provided as a coupling place of amounting object including a plurality of supports, for example, pole shafts.

In the embodiment, as illustrated in FIG. 4, the ball connector part 200 includes a plurality of ball members 210 disposed in the plurality of space portions provided by the plurality of lower cutout holes 111 and the plurality of upper cutout holes 121, and a connector body 220 of which one side is provided on the plurality of ball members 210 and the other side is detachably coupled with the mounting object.

The plurality of ball members 210 of the ball connector part 200 may have a spherical shape, as illustrated in FIG. 4.

In addition, in the embodiment, since the plurality of ball members 210 are hollow, the surfaces of the plurality of ball members 210 are crushed to a certain depth by the pressing force of the lower body 110 and the upper body 120, so that the positions thereof may be fixed by the lower body 110 and the upper body 120. In the embodiment, the case that the surfaces of the ball members 210 are crushed to a certain depth includes a case where a portion in which the ball members 210, the lower body 110 and the upper body 120 contact each other is partially or entirely crushed.

In the embodiment, providing the plurality of ball members 210 to be hollow may be divided into two methods.

First, there is a method of increasing a fixing force by using an elastic force of the plurality of ball members 210.

This method is to increase a seating force of the plurality of ball members 210 by crushing the plurality of ball members 210 by the lower body 110 and the upper body 120 when the lower body 110 and the upper body 120 that presses the plurality of ball members 210 are pressed with the lever part 500. That is, the reason is mainly to increase the seating force on the lower body 110 and the upper body 120 on which the plurality of crushed ball members 210 are seated to increase a fixing force.

In addition, the plurality of ball members 210 are crushed into an elliptical shape like a rugby ball while being pressed to be prevented from being rotated or removed from a place to be seated. For example, when inserting the precision-machined shaft into the hole, an effect that the shaft or the hole is finely filled with foreign substances or crushed to prevent coupling is used in reverse.

Therefore, in order for the plurality of ball members 210 to be uniformly crushed into an elliptical shape, an available space is required to be crushed and seated even in the lower body 110 and the upper body 120.

That is, in the illustrated drawings, the diameters of the plurality of ball members 210 are 26 phi, and the diameters of the holes provided in the lower body 110 and the upper body 120 may be made to be larger than 26 phi. This is to secure an available space by manufacturing the size of the intended crushing of the plurality of ball members 210.

In addition, the plurality of ball members 210 are subjected to a continuous operation of being crushed and returned to their original state, and an elastic material capable of returning to the original shape even after long-time storage by fixing the support frame (by crushing the balls) and a thickness of the surface of the plurality of hollow ball members 210 need to have an important moment.

For example, the thickness of the surface of the plurality of ball members 210 is processed to be 0.5 mm, and even in repetitive locking and unlocking and the long-term storage in the locking state, the plurality of ball members 210 having elasticity that is returned to their original state, an available space of the lower body 110 and the upper body 120, and a thickness of the surface of the plurality of ball members 210 have a predetermined moment.

Accordingly, in the case of manufacturing a support frame with a higher or lower supporting force than the illustrated support frame, products having various supporting forces may be manufactured by making a moment of the available space between the lower body 110 and the upper body 120 and the plurality of ball members 210 when the thickness of the plurality of hollow ball members 210 is thicker or thinner than the example.

A second is a method for simultaneously fixing a plurality of ball members 210, for example, four ball members 210.

When a non-hollow ball (having no elastic force) is pressed by the lower body 110 and the upper body 120, a supporting force (fixing) effect that is tightly pressed may occur. However, as the lever is pressed by a user, the lever has no choice but to be fixed with only the pressing force to be pressed by the user, and thus, there is a problem of inconvenience of a practical user and weak fixation. When the four balls are simultaneously fixed, the four balls are equally processed theoretically exactly as described above, and the seating groove in which the balls of the lower body 110 and the upper body 120 are seated is difficult to be precisely processed.

In fact, even with a slight error (around 0.01 mm), when the four balls are fixed at the same time, only three balls are fixed, and one ball thereof has a significantly weaker fixing force than other three balls.

Also, if a foreign substance gets caught in any one of the balls even during multiple uses, the four balls are not fixed at the same time.

In particular, the support frame using the fixing force of the ball members 210 of the embodiment has a predetermined fixing force or more even if the support frame is fixed by crushing the balls at a certain fixing force to be naturally bent and thus has a function of preventing damage of the embodiment. In other words, even if the balls are crushed, the balls rotate by a designed force or more (in the presence of pressed pressure) to prevent damage to the support frame.

That is, there is an advantage of simultaneously pressing the four ball members 210 by using the plurality of ball members 210 crushed.

This is characterized in that the ball members 210 are crushed even after the three ball members 210 are first pressed with the lower body 110 and the upper body 120 to press the other ball member 210.

Therefore, the hollow ball member 210 of the embodiment is characterized in that when the plurality of ball members 210 is pressed with the lever part 500, a difference in dimension between the four ball members 210, or a difference in dimension between four grooves provided in the lower body 110 and the upper body 120 and provided as a seating space of the ball members 210/even when foreign substances are inserted has the same pressing force. (The pressing force inclined to one side is not finely shown on the lower body 110 and the upper body 120, but the same pressing force may be maintained while being inclined in an opposite direction to the direction of the pressing force received first)

In addition, in pressing balls that are not hollow, a limit or more of ductility or elasticity, which are the characteristics of the material of the ball, cannot be pressed with a human force.

In other words, as a result, the user's operation ability is expanded to a depth to be crushed so that the user can easily manipulate (fix/release) by deriving a hollow ball. Accordingly, when the force capable of being applied to the balls is large, the supporting force is increased to increase a reference width of the force capable of being applied by the user using the hollow balls.

Here, the clamping head 510 and the lever handle 520 of the lever part 500 to be described below are provided in a double lever structure, so that there is an advantage that the user can easily and conveniently operate the fixing and releasing of the plurality of ball members 210.

Furthermore, in the embodiment, the plurality of ball members 210 may be specially treated to increase a frictional force with the lower body 110 and the upper body 120. In the embodiment, the surfaces of the plurality of ball members 210 are subjected to an operation selected from, for example, sanding treatment, surface treatment, and heat treatment to increase a frictional force.

The connector body 220 of the ball connector part 200 may be manufactured integrally with the plurality of ball members 210, or may be separately manufactured to be fitted and screw-coupled to the plurality of ball members 210.

In the embodiment, amounting object to be mounted on the connector body 220 maybe coupled in a known manner such as screw coupling and fitting coupling.

As shown in FIG. 7, the fastening part 300 is rotatably coupled to the lower body 110 and the upper body 120 to press the lower body 110 and the upper body 120 in a direction facing each other. As a result, the plurality of ball members 210 provided by the lower body 110 and the upper body 120 may be crushed to a certain depth by the pressing force of the lower body 110 and the upper body 120 to be fixed in position.

In the embodiment, as illustrated in FIG. 3, the fastening part 300 includes a shaft part 400 coupled to the lower body 110 and the upper body 120, a lever part 500 which is rotatably coupled to the shaft part 400 to press the lower body 110 and the upper body 120 in a direction of the plurality of ball members 210, a lower rotation support part which is supported by a base body 410 of the shaft part 400 disposed on a lower surface of the lower body 110 to support the rotation of the shaft part 400, and an upper rotation support part 700 through which a lever shaft 420 of the shaft part 400 disposed on an upper surface of the upper body 120 penetrates in the center to support the rotation of the shaft part 400.

As illustrated in FIG. 3, the shaft part 400 of the fastening part 300 includes a base body 410 coupled to a lower side of the lower body 110, a lever shaft 420 coupled to the upper portion of the base body 410 by penetrating through the central portion of the upper body 120, and a fastening member 430 coupled to an inner portion of the base body 410 and an inner portion of the lever shaft 420, respectively, to couple the base body 410 and the lever shaft 420 to each other.

In the upper side of the base body 410 of the shaft part 400, as illustrated in FIG. 4, a coupling post 411 is provided, and a central portion of the coupling post 411 is provided with a cutout portion at a predetermined depth. In the embodiment, a lower side of the lever shaft 420 illustrated in FIG. 4 is inserted into the cutout portion of the coupling post 411, and the insertion depth may be a depth corresponding to a cutout groove 422 provided in the lever shaft 420.

In addition, in the embodiment, in a middle portion of the base body 410, as illustrated in FIG. 4, a lower support flange 412 is provided, and on the upper surface of the lower support flange 412, as illustrated in FIG. 3, a lower rotation guide member 610 of the lower rotation support part 600 may be supported.

As illustrated in FIG. 3, the lever shaft 420 of the shaft part 400 is coupled to the base body 410 by the fastening member 430 and ascends or descends (elevates) with the fastening member 430 when rotating the lever part 500 to guide the lower body 110 and the upper body 120 to press the ball members 210.

In the embodiment, as illustrated in FIG. 4, a pair of hinge shafts 421 are spaced apart from each other at the upper side of the lever shaft 420, and a pair of cutout grooves 422 may be spaced apart from each other at the lower end of the lever shaft 420.

In the embodiment, as illustrated in FIG. 3, when the lever part 500 is coupled to the lower body 110 and the upper body 120, the lever shaft 420 is in a state coupled to the fastening member 430. In this case, the head of the coupling member is caught and supported by a locking step provided on an inner wall of the base body 410. In this state, when the lever part 500 is rotated in a dotted line direction illustrated in FIG. 7, the lever shaft 420 and the fastening member 430 are moved downward based on FIG. 3 to release the locked state of the plurality of ball members 210.

As illustrated in FIG. 4, the fastening member 430 of the shaft part 400 may have a bar shape having an extended head.

In the embodiment, as illustrated in FIG. 3, the fastening member 430 has one side which penetrates through the central portion of the base body 410 to be coupled to the inside of the lever shaft 420 with a known coupling means including fitting coupling or screw coupling.

In addition, in the embodiment, the fastening member 430 may also be used for adjusting the pressure of the lever part 500 according to a weight of the support by a user, for example, a woman or a child with a weak force.

The lever part 500 of the fastening part 300 is rotatably coupled to the lower body 110 and the upper body 120 and presses the upper body 120 and the lower body 110 in a direction facing each other to fix the positions of the plurality of ball members 210.

In the embodiment, the lever part 500 includes a clamping head 510 having an upper end rotatably coupled to the hinge shaft 421 of the lever shaft 420 illustrated in FIG. 4 and the other portion inserted to the upper fastening groove 122 and the lower fastening groove 112 to press the lower body 110 and the upper body 120 in a direction facing each other, a lever handle 520 coupled to the lower end of the clamping head 510 as illustrated in FIG. 3, and an extension part 530 provided on a lower end of the lever handle 520 with a larger width than the lever handle 520.

The lever handle 520 of the lever part 500 may be hinged with the clamping head 510, and may rotate integrally with the clamping head 510.

The lower rotation support part 600 of the fastening part 300 is disposed in a space between the base body 410 and the lower side of the lower body 110, as illustrated in FIG. 3, to guide the rotation of the shaft part 400 in a clockwise or counterclockwise direction.

In the embodiment, as illustrated in FIG. 3, the lower rotation support part 600 includes a lower rotation guide member 610 of which a lower side is supported by the upper surface of the lower support flange 412 and a lower cover flange 620 disposed on the lower rotation guide member 610 to cover the upper portion of the lower rotation guide part.

In the embodiment, the lower rotation guide member 610 includes a circular bearing in which a plurality of balls are spaced apart from each other, as illustrated in FIG. 4.

The upper rotation support part 700 of the fastening part 300, as illustrated in FIG. 3, is disposed in a recessed groove provided on the upper surface of the upper body 120 to guide the rotation of the lever shaft 420 in a clockwise or counterclockwise direction.

In the embodiment, the upper rotation support part 700, as illustrated in FIG. 3, includes an upper support flange 710 supported on a bottom portion of the recessed groove of the upper body 120, an upper rotation guide member 720 supported by the upper surface of the upper support flange 710, and an upper cover flange 730 covering the upper portion of the upper rotation guide member 720 and through which the lever shaft 420 penetrates.

In the embodiment, the upper rotation guide member 720 includes a circular bearing in which a plurality of balls are spaced apart from each other, as illustrated in FIG. 4.

As described above, the present invention is not limited to the embodiments described herein, and it will be apparent to those skilled in the art that various changes and modifications may be made without departing from the spirit and the scope of the present invention. Therefore, it will be understood that these changes and modifications are included in the appended claims of the present invention.

What is claimed is:

1. A support frame comprising:
a support main body having a lower body provided with a plurality of lower cutout holes and an upper body provided with a plurality of upper cutout holes at positions corresponding to the plurality of lower cutout holes;
a ball connector part provided with a plurality of ball members disposed in a plurality of space portions provided by the plurality of lower cutout holes and the plurality of upper cutout holes and coupled with a mounting object including at least one support; and
a fastening part which is provided on the support main body and presses the plurality of hollow ball members by the lower body and the upper body to fix the positions of the plurality of ball members.

2. The support frame of claim 1, wherein the fastening part comprises:
a shaft part coupled to the lower body and the upper body; and
a lever part rotatably coupled to the shaft part to press the lower body and the upper body in a direction of the plurality of ball members.

3. The support frame of claim 2, wherein the lever part comprises:
a clamping head which is rotatably coupled on an upper end of the shaft part and inserted into an upper fastening groove provided on the upper body and a lower fastening groove provided on the lower body to press the upper body and the lower body; and
a lever handle which is provided on a lower end of the clamping head to be provided as a handle of a user.

4. The support frame of claim 3, wherein the lever part further comprises an extension part provided at a lower end of the lever handle with a larger width than the lever handle.

5. The support frame of claim 3, wherein the lever part further comprises:
a lower rotation support part which is supported by a base body of the shaft part disposed on a lower surface of the lower body to support the rotation of the shaft part; and
an upper rotation support part through which the lever shaft of the shaft part disposed on the upper surface of the upper body passes in the central portion to support the rotation of the shaft portion.
